(19) United States
(12) Patent Application Publication
(10) Pub. No.: US 2009/0051669 A1
(43) Pub. Date: Feb. 26, 2009

(54) APPARATUS AND METHOD FOR INPUTTING FUNCTION KEY

(75) Inventor: Keun-Ho SHIN, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/197,864

(22) Filed: Aug. 25, 2008

(30) Foreign Application Priority Data
Aug. 23, 2007 (KR) 2007-0084942

(51) Int. Cl. G06F 3/041

(52) U.S. Cl. 345/173

(57) ABSTRACT

An apparatus and a method for inputting a function key. The apparatus and method provide convenience with which a user can use function keys of a QWERTY-type keyboard, such as direction keys and cursor movement keys, in a small-sized terminal. Also, the apparatus and method enable easy input of various function keys, and can thus increase the efficiency of inputting the function keys.

### PRIORITY

This application claims priority under 35 U.S.C. §119(a) to an application filed in the Korean Industrial Property Office on Aug. 23, 2007 and assigned Serial No. 2007-84942, the contents of which are hereby incorporated by reference.

### BACKGROUND OF THE INVENTION

1. Field of the Invention

The present invention generally relates to a terminal equipped with a touch-screen, and more particularly to an apparatus and method for inputting a function key.

2. Description of the Related Art

Recently, mobile communication terminals, including cell phones, Personal Digital Assistants (PDAs), etc., equipped with standard QWERTY-type keypads for computer keyboards have appeared. Accordingly, a user has convenience in that he/she can easily input a key by using a relevant terminal in the same manner as when he/she uses a computer.

Meanwhile, a user moves a location of a cursor and edits characters usually in a character editing mode. The cursor is generally a small symbol indicating a location for modifying or inputting a particular character, and is usually displayed as a blinking underline or an inverted square. Accordingly, when editing characters, the user can designate a location for editing, moving the location of the cursor.

In order to move the location of the cursor, the user uses direction keys or cursor movement keys in a QWERTY-type keyboard. The direction keys include an upward (↑) key, a downward (↓) key, a leftward (←) key and a rightward (→) key, and are used to move the cursor in upward, downward, leftward, and rightward directions, respectively. Also, the cursor movement keys include a Page Up key, a Page Down key, a Home key and an End key. Among them, the Page Up key is used to move the cursor upward by one page, whereas the Page Down key is used to move the cursor downward by one page. Also, the Home page is used to move the cursor to the beginning of a sentence or a document, whereas the End key is used to move the cursor to the end of a sentence or a document. Accordingly, in the character mode, the user can more easily edit characters when he/she uses the direction keys and the cursor movement keys.

A conventional QWERTY-type keyboard is normally equipped with function keys, such as direction keys and cursor movement keys for moving a location of a cursor. However, since function keys as described above are implemented as separate keys in conventional keyboards, when a user intends to input a desired function key, there is inconvenience in that he/she must select a relevant function key from among the function keys. Moreover, when a QWERTY-type keypad is intended to be applied to a mobile communication terminal, the application has difficulties in implementing all keys according to the layout of the QWERTY-type keyboard in the terminal which is getting smaller.

Due to the above-described problems, a need exists for a method capable of efficiently configuring a keypad and providing more various function keys.

### SUMMARY OF THE INVENTION

Accordingly, the present invention substantially solves the above-described problems occurring in the prior art, and provides an apparatus and a method for more conveniently inputting each function key by efficiently displaying the function keys, such as direction keys and cursor movement keys, on a touch-screen of a terminal.

In accordance with an aspect of the present invention, there is provided a method for inputting a function key in a terminal equipped with a touch-screen, the method including determining whether a Press event occurs in a function key area enabling selective use of any direction keys and cursor movement keys; when the Press event occurs, respectively assigning any of the direction keys and the cursor movement keys to key areas, and displaying the keys respectively assigned to the key areas; and when a Release event occurs in the function key area, releasing the assignment of the displayed keys to restore each of the key areas to a display state that was present before the occurrence of the Press event, and displaying the restored key areas.

In accordance with another aspect of the present invention, there is provided an apparatus for inputting a function key, the apparatus including a touch-screen for outputting a character received as an input, displaying a function key area enabling selective use of any direction keys and cursor movement keys, and generating any of a Press event, a Release event, and a Drag event in response to an input of a user; a memory for storing therein functions respectively corresponding to the direction keys and the cursor movement keys; and a control unit for controlling the touch-screen to display the function key area on the touch-screen, respectively assigning any of the direction keys and the cursor movement keys to key areas and displaying the keys respectively assigned to the key areas when the Press event occurs in the function key area, and releasing the assignment of the displayed keys to restore each of the key areas to a display state that was present before the occurrence of the Press event and displaying the restored key areas when the Release event occurs in the function key area.

### BRIEF DESCRIPTION OF THE DRAWINGS

The above and other features, aspects, and advantages of the present invention will be more apparent from the following description taken in conjunction with the accompanying drawings, in which:

FIG. 1 is a block diagram illustrating a configuration of a terminal providing function keys according to the present invention;

FIG. 2 an illustrative view showing a keypad displayed on a touch-screen according to the present invention;

FIGS. 3(a) and 3(b) are illustrative views showing direction keys and cursor movement keys respectively displayed in key areas according to the present invention;

FIG. 4 is a flowchart illustrating a control process of selecting the direction keys in character editing mode according to the present invention;

FIG. 5 is a flowchart illustrating a control process of selecting the cursor movement keys in the character editing mode according to the present invention;

FIG. 6 is a flowchart illustrating a control process of displaying the direction keys or the cursor movement keys based on a touch input time in the character editing mode according to the present invention;

FIG. 7 are illustrative views showing a selection process of a Select key according to the present invention; and

FIGS. 8(a) and 8(b) are illustrative views showing a selection process of a Lock key according to the present invention.

### DETAILED DESCRIPTION OF THE PREFERRED EMBODIMENTS

Hereinafter, preferred embodiments of the present invention will be described in detail with reference to the accompanying drawings. In the following description of the present invention, a detailed description of known functions and configurations incorporated herein will be omitted when it may make the subject matter of the present invention rather unclear.

The present invention provides an apparatus and a method for inputting a function key. To this end, a terminal equipped with a touch-screen according to the present invention determines whether a Press event occurs in a function key area enabling selective use of either direction keys or cursor movement keys. When a Press event occurs, the terminal respectively assigns any of the direction keys and cursor movement keys to key areas, and displays the keys respectively assigned to the key areas. When a Release event occurs in the function key area, the terminal releases the assignment of the displayed keys to restore each of the key areas to a display state that was present before the occurrence of the Press event, and displays the restored key areas. Accordingly, the present invention provides convenience in that a user can use more function keys in the terminal, and can easily select various function keys.

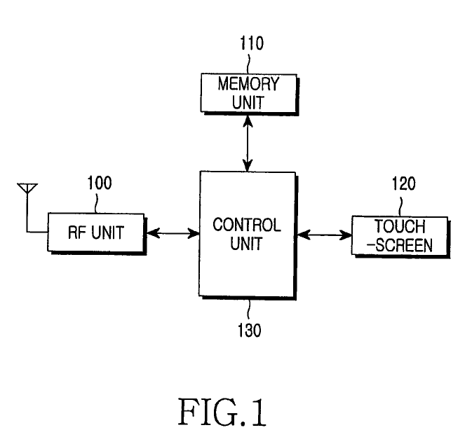

A description will now be made of a configuration of a terminal providing function keys according to an embodiment of the present invention with reference to FIG. 1.

Referring to FIG. 1, the terminal providing the function keys includes a Radio Frequency (RF) unit 100, a memory unit 110, a touch-screen 120, and a control unit 130.

The RF unit 100 performs a radio communication function of the terminal. The memory unit 110 includes a Read Only Memory (ROM) and a Random Access Memory (RAM) for storing multiple programs and data therein. Particularly, the memory 110 stores therein, for example, Hangul, English, numerals, special characters, etc., referred to herein as “characters”, displayed in character areas of the touch-screen 120 for a keypad function according to the present invention. Also, the memory 110 stores therein functions respectively corresponding to the direction keys and the cursor movement keys corresponding to the function keys according to the present invention. The direction keys include at least one of an upward (↑) key, a downward (↓) key, a leftward (←) key, and a rightward (→) key. The cursor movement keys include at least one of a Page Up key, a Page Down key, a Home key, and an End key.

The touch-screen 120 is a display which can detect a location of touch when a human hand or an object touches a character or a particular location displayed on a screen thereof, and can then perform particular processing by using stored software. The touch-screen 120 receives touch input from a user and displays expression data under the control of the control unit 130, or displays an operation state of the terminal and multiple pieces of information as icons and characters. Particularly, the touch-screen 120 to which the present invention is applied displays character areas for character input and an input editor window for editing input characters under the control of the control unit 130. Also, in a character editing mode, the touch-screen 120 outputs a character received as input through the character area to the input editor window, and displays a cursor indicating a location for editing along with the output character.

Meanwhile, the touch-screen 120 displays a function key area enabling selective use of any of the direction keys and the cursor movement keys, and generates a Press event in response to the input of the user. Also, the touch-screen 120 generates a Release event and a Drag event in response to the input of the user in each of the key areas which respectively display the direction keys or the cursor movement keys. The Press event occurs when a particular key area is pressed, and the Release event occurs when the pressing of the particular key area is released. Also, the Drag event occurs when a Drag input is received from the user in the key areas displayed on the touch-screen 120. Accordingly, the user can easily input a desired function key in the input scheme as described above.

The control unit 130 performs an overall control operation of the terminal. Also, according to the present invention, the control unit 130 determines whether a Press event occurs in a function key area. When it is determined that a Press event occurs, the control unit 130 respectively assigns any of the direction keys and cursor movement keys to the key areas, and displays the keys respectively assigned to the key areas. When a Release event occurs in the function key area, the control unit 130 releases the assignment of the direction keys or the cursor movement keys, respectively displayed in the key areas. The release of the assignment is performed so that the control unit 130 may restore each of the key areas to a display state that was present before the occurrence of the Press event and display the restored key areas.

Meanwhile, if a Press event occurs again in a state of restoring the key areas to display the restored key areas, the control unit 130 respectively displays, in the key areas, keys different from the keys previously displayed in the key areas among the direction keys and the cursor movement keys. For example, if the direction keys are first displayed in response to the occurrence of the Press event, the cursor movement keys are displayed in response to the next occurrence of a Press event. Accordingly, the present invention provides the user with convenience in that he/she can selectively use the direction keys or the cursor movement keys when editing characters.

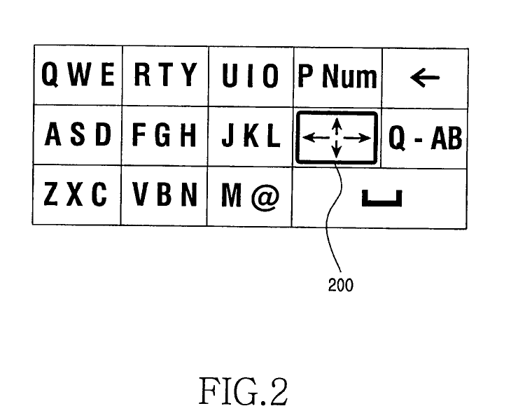

A description will now be made of a keypad displayed on the touch-screen according to the present invention with reference to FIG. 2.

Referring to FIG. 2, multiple characters are displayed in a QWERTY format in each character area in the keypad. Also, several editing keys used when inputting characters are displayed in the key areas on the right side of the character areas. The following description will be made of a function key area 200 enabling selective use of the function keys, such as the direction keys and the cursor movement keys, among the displayed editing keys according to the present invention.

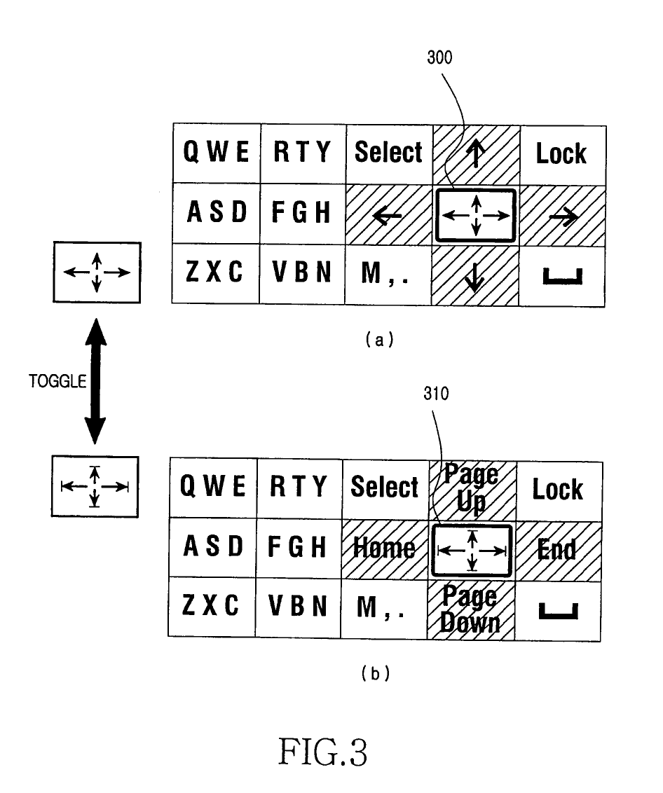

Referring to FIG. 2, an identifier indicating usable keys of either the direction keys or the cursor movement keys is displayed in the function key area 200. Accordingly, when an identifier indicating that it is possible to use the direction keys is displayed in the unction key area 200, the user can select and use each of upward (T), downward (↓), leftward (←), and rightward (→) direction keys displayed as illustrated via function key area 300 in FIG. 3(a). Other than this, when an identifier indicating the use of the cursor movement keys is displayed in the function key area 200, the user can select and use each of the cursor movement keys, including Page Up, Page Down, Home, and End keys, displayed as illustrated via function key area 310 in FIG. 3(b). As described above, in the present invention, the user views the identifier displayed in the function key area 200 of FIG. 2, and can recognize currently usable keys among the direction keys and the cursor movement keys.

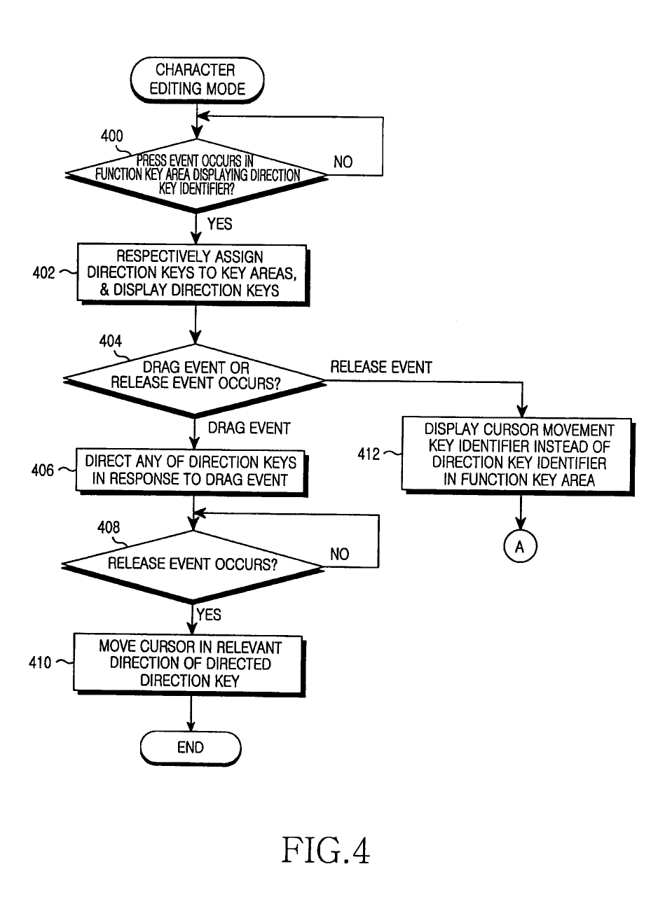

A description will now be made of a control process of selecting the direction keys in a character editing mode according to the present invention with reference to FIG. 4.

Referring to FIG. 4, the description is made taking, as an example, a case of displaying the identifier indicating that it is possible to use the direction keys, referred to herein as the “direction key identifier”, in the function key area.

Accordingly, while performing the character editing mode, the control unit 130 determines in step 400 whether a Press event occurs in the function key area displaying the direction key identifier. If it is determined that a Press event occurs, the control unit 130 proceeds to step 402, respectively assigns the direction keys to the key areas, and displays the direction keys respectively assigned to the key areas. Accordingly, the direction keys are displayed as illustrated in FIG. 3(a).

Namely, when the Press event occurs in the function key area 300 of FIG. 3(a) displaying the direction key identifier, each of the upward (↑), downward (↓), leftward (←), and rightward (→) direction keys is displayed in the relevant key area located in each direction, centering on the function key area 300 where the Press event occurs. According to the present invention, the direction keys can be displayed in either two or more character areas respectively assigned at least one character for character input, a pop-up window, or others. Namely, the direction keys may be displayed instead of key items or characters in all of the key areas displayed on the touch-screen 120, and may be displayed in a newly generated pop-up window. According to the present invention, it may be possible to change a display scheme of the direction keys in various forms.

In a state of displaying the direction keys as described above, the control unit 130 proceeds to step 404, and determines whether a Drag event or a Release event occurs. If it is determined that a Drag event occurs, the control unit 130 proceeds to step 406, and directs any of the direction keys in response to the Drag event. If it is determined in step 408 that a Release event occurs, the control unit 130 proceeds to step 410, and moves a cursor in a relevant direction of the directed direction key.

Specifically, referring to FIG. 3(a), if the direction keys are assigned to the key areas and displayed in the key areas, respectively, the control unit 130 determines whether a Drag event occurs. If it is determined that a Drag event occurs, the control unit 130 directs any of the direction keys in a direction of the Drag event. When it is determined that a Release event occurs in a directed direction key area, the control unit 130 moves the cursor in a particular direction corresponding to the directed direction key. For example, if a Release event occurs in an area (i.e. a direction key area) displaying the rightward (→) direction key from among the upward (↑), downward (↓), leftward (←), and rightward (→) direction keys, the control unit 130 moves the cursor sideways by a character in the right direction.

Meanwhile, if it is determined in step 404 that a Release event occurs, the control unit 130 proceeds to step 412. In step 412, the control unit 130 displays an identifier indicating that it is possible to use the cursor movement keys, referred to herein as a “cursor movement key identifier”, instead of the direction key identifier in the function key area. At this time, the control unit 130 releases the assignment of the upward (↑), downward (↓), leftward (←), and rightward (→) direction keys, which are assigned to the key areas and displayed in the key areas, respectively. Then, the control unit 130 restores each of the relevant key areas to a display state that was present before the occurrence of the Press event in the function key area. For example, if the leftward (←) direction key is assigned instead of “JKL” to a character area displaying “JKL”, and is displayed in the character area, the control unit 130 releases the assignment of the leftward (←) direction key, and then displays “JKL” again. Accordingly, a user has convenience with which he/she can input a direction key and can then continue to input characters.

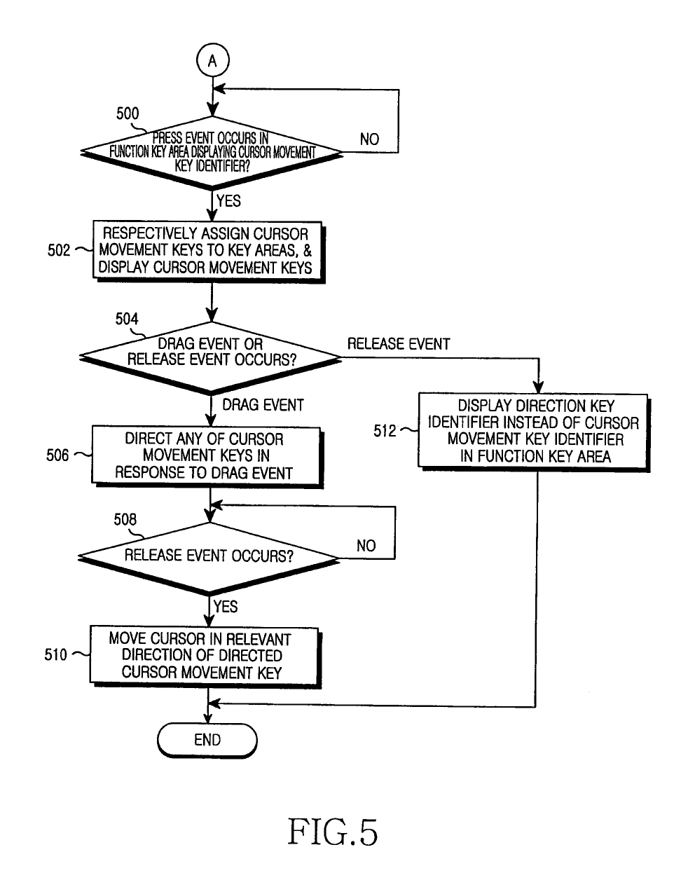

In the present invention, when a Release event occurs immediately after the occurrence of a Press event in the function key area displaying the direction key identifier, the control unit 130 displays the cursor movement key identifier in the function key area so that the user can use the cursor movement keys instead of the direction keys. Namely, the control unit 130 changes an identifier displayed in the function key area from the direction key identifier to the cursor movement key identifier, thereby informing the user that the use of the cursor movement keys is designated. In order to determine whether the cursor movement keys are used, the control unit 130 proceeds from step 412 to the next step. In FIG. 4, a symbol “A” representing a step following step 412 is used in order to show that step 412 as illustrated in FIG. 4 may be connected to step 500 as illustrated in FIG. 5.

Steps following step 412 will now be described referring to FIG. 5, which illustrates a control process of selecting the cursor movement keys in the character editing mode according to the present invention.

Referring to FIG. 5, the control unit 130 determines in step 500 whether a Press event occurs in a function key area displaying the cursor movement key identifier. If it is determined that a Press event occurs, the control unit 130 proceeds to step 502, respectively assigns the cursor movement keys to the key areas, and displays the cursor movement keys respectively assigned to the key areas. Namely, when a Press event occurs in a function key area 310 displaying the cursor movement key identifier, the control unit 130 displays each of the Page Up, Page Down, Home, and End keys corresponding to the cursor movement keys in a key area located in each direction, centering on the function key area 310 where the Press event occurs, as illustrated in FIG. 3(b).

In a state where the cursor movement keys are displayed as described above, the control unit 130 proceeds to step 504, and determines whether a Drag event or a Release event occurs. If it is determined that a Drag event occurs, the control unit 130 proceeds to step 506, and directs any of the cursor movement keys in response to the Drag event. When it is determined in step 508 that a Release event occurs, the control unit 130 proceeds to step 510, and moves the cursor in a relevant direction of the directed cursor movement key. In other words, the control unit 130 moves a location of the cursor either on a sentence-by-sentence basis or on a page-by-page basis in a particular direction corresponding to the directed cursor movement key. As described above, a process of selecting the cursor movement keys is similar to the process of selecting the direction keys. Accordingly, when the cursor movement keys are respectively displayed in the key areas, the user selects a desired one of the cursor movement keys through a Drag event, and generates a Release event, so that he/she can perform a function corresponding to the relevant cursor movement key.

Meanwhile, when it is determined in step 504 that a Release event occurs, the control unit 130 proceeds to step 512, and displays the direction key identifier instead of the cursor movement key identifier in the function key area. Namely, when a Release event occurs immediately after the Press event occurs in the function key area, in a toggle scheme, the control unit 130 changes an identifier from the cursor movement key identifier to the direction key identifier, and displays the changed direction key identifier. Accordingly, FIG. 5 illustrates all steps in such a manner that they are completed, but the control unit 130 returns to step 400 and repeats the steps as described above. Accordingly, the user has convenience in that he/she can more conveniently select and use either the direction keys or the cursor movement keys through the process as described above.

In another embodiment of the present invention, by selecting a direction of a Drag event differently from the embodiment as described above, a user can input the direction keys or the cursor movement keys. Specifically, the control unit 130 determines whether a Drag event occurs when a Press event occurs in the function key area displaying the direction key identifier or the cursor movement key identifier. At this time, even though a Press event occurs, the control unit 130 does not display the direction keys or the cursor movement keys. Accordingly, the control unit 130 can separately display relevant information so that the user can recognize which key corresponds to each direction in either the direction keys or the cursor movement keys along with the identifier in the function key area.

Meanwhile, according to another embodiment of the present invention, if it is determined that a Drag event occurs, the control unit 130 detects a direction of the Drag event, centering on the function key area. Then, the control unit 130 identifies a key corresponding to the detected direction among either the direction keys or the cursor movement keys, and performs a function corresponding to the identified key when a Release event occurs. Namely, when the identified key is a direction key, the control unit 130 moves a location of a cursor on a character-by-character basis. Other than this, when the identified key is a cursor movement key, the control unit 130 moves the location of the cursor either on a sentence-by-sentence basis or on a page-by-page basis. Through the method as described above, the user can save time used to input a function key.

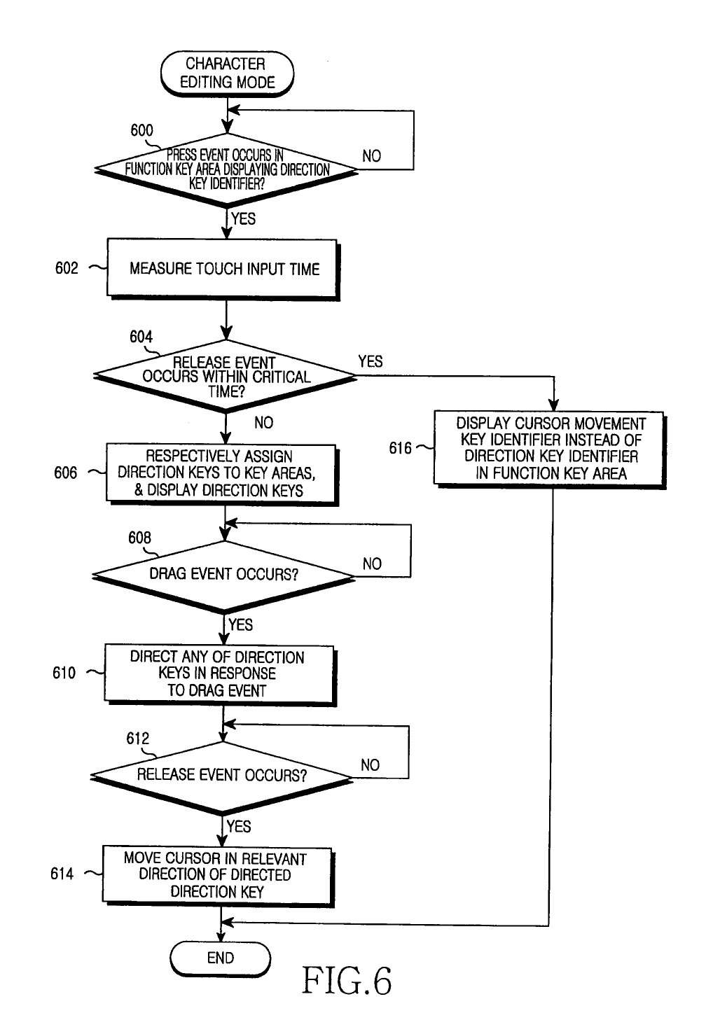

In the two embodiments as described above, the control unit 130 selectively displays either the direction keys or the cursor movement keys based on whether there exists a Drag event. Also, the control unit 130 may display the direction keys or the cursor movement keys based on a duration time of a Press event in the function key area. A description of this will now be made referring to FIG. 6, which illustrates a control process of displaying the direction keys or the cursor movement keys based on a touch input time in the character editing mode according to of the present invention.

Referring to FIG. 6, while performing the character editing mode, the control unit 130 determines in step 600 whether a Press event occurs in the function key area displaying the direction key identifier. When it is determined that a Press event occurs, the control unit 130 proceeds to step 602, and measures a touch input time. According to this embodiment of the present invention, the term “touch input time” refers to an elapsed time from a time point of the occurrence of a Press event in the function key area. The touch input time is used as reference for selective display of either the direction keys or the cursor movement keys shown in FIG. 6.

Accordingly, the control unit 130 compares a touch input time with a critical time, and determines whether a Release event occurs within the critical time. If it is determined that a Release event does not occur, the control unit 130 proceeds to step 606, respectively assigns the direction keys to the key areas, and displays the direction keys respectively assigned to the key areas. When it is determined in step 608 that a Drag event occurs, the control unit 130 proceeds to step 610, and directs any of the direction keys in response to the Drag event. Then, the control unit 130 determines in step 612 whether a Release event occurs in an area displaying the directed direction key. If it is determined that a Release event occurs, the control unit proceeds to step 614, and moves a cursor in a relevant direction of the directed direction key.

Meanwhile, when it is determined in step 604 that the Release event occurs within the critical time, the control unit 130 proceeds to step 616, and displays the cursor movement key identifier instead of the direction key identifier in the function key area. After the cursor movement key identifier is displayed in the function key area, the control unit 130 may change the cursor movement key identifier to the direction key identifier and display the changed direction key identifier, in response to the touch input time, as described above.

In FIG. 6, if a time when a Press event occurs in the function key area exceeds the critical time, the control unit 130 respectively assigns either the direction keys or the cursor movement keys to the key areas and displays the relevant keys respectively assigned to the key areas, in response to an identifier displayed in the function key area. On the contrary, if a time when a Press event occurs in the function key area does not exceed the critical time, the control unit 130 changes an identifier displayed in the function key area from the direction key identifier to the cursor movement key identifier or vice versa.

As described above, the present invention provides a method for inputting the function keys, such as the direction keys and the cursor movement keys, in various ways, and accordingly, provides the advantages that the convenience of the user increases and the user can use more function keys even in a small-sized terminal.

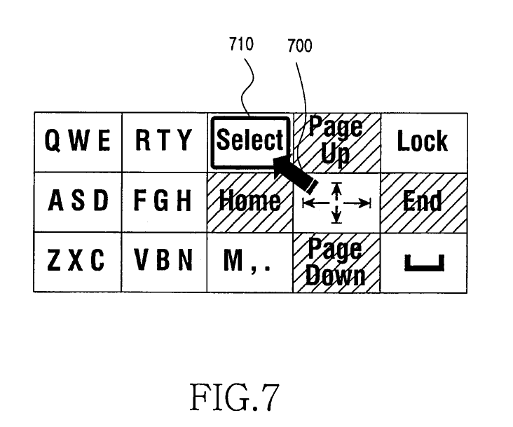

Meanwhile, in order to more easily use the function keys as described above, the present invention additionally provides a Select key and a Lock key. According to the present invention, the Select key is used to specify characters output in the input editor window on a block-by-block basis. When a Press event occurs in the function key area 700 displaying the cursor movement key identifier as illustrated in FIG. 7, the Select key 710 is additionally assigned to a relevant key area along with the cursor movement keys, and is displayed in the relevant key area. This is also the same when the direction keys are simultaneously displayed while the direction key identifier is displayed in the function key area 700. Accordingly, the user directs the Select key 710 through a Drag event and then generates a Release event, so that he/she can specify characters on a block-by-block basis.

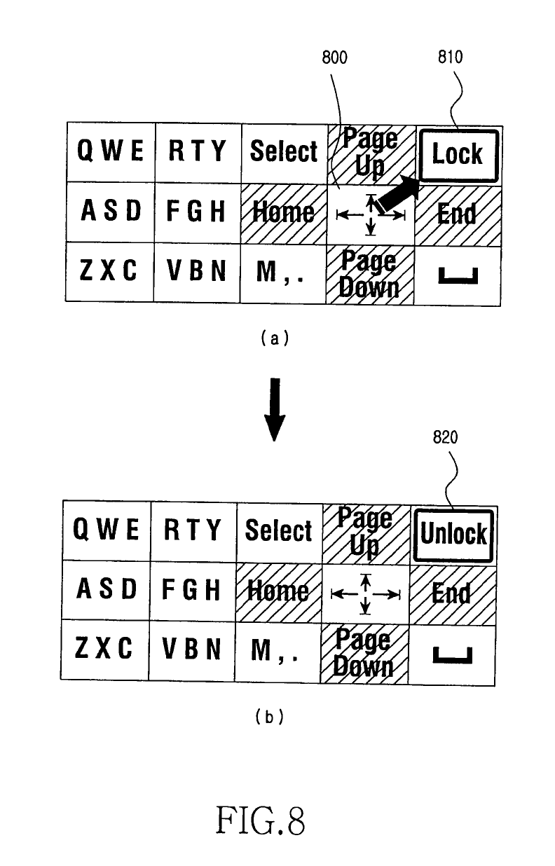

In the same manner as the Select key, the Lock key is assigned to a relevant key, area along with the direction keys or the cursor movement keys, and is displayed in the relevant key area. The Lock key is used so that the direction keys or the cursor movement keys may continue to be displayed even after a Release event occurs. A description of the Lock key as described above will be made as follows referring to FIGS. 8(a) and 8(b). FIG. 8(a) shows that the Lock key 810 is displayed along with the cursor movement keys. Hence, the user generates a Press event in the function key area 800 and then selects an area (i.e. a Lock key area) displaying the Lock key 810 through a Drag event. Then, the user generates a Release event in the Lock key area, so that the cursor movement keys respectively displayed in the key areas can be fixedly displayed. At this time, according to the present invention, the Lock key area as described above can be changed to an area (i.e. an Unlock key area) displaying an Unlock key 820, and the Unlock key can then be displayed in the Unlock key area, as illustrated in FIG. 8(b). For this reason, when the user intends to release the function of fixedly displaying the cursor movement keys, he/she selects the Unlock key 820, so that he/she can input each of the cursor movement keys in the original way. Similarly to this, after the Select key is input by the user, the Select key may also be changed to an Unselect key, and the Unlock key is displayed in the relevant key area. Hence, the user has convenience in that he/she can more conveniently input the direction keys and the cursor movement keys by using the Select and Lock keys.

While the invention has been shown and described with reference to certain preferred embodiments thereof, it will be understood by those skilled in the art that various changes in form and details may be made therein without departing from the spirit and scope of the invention. Therefore, the spirit and scope of the present invention should be understood to be defined not by described embodiments thereof but by the appended claims and equivalents of the appended claims.

What is claimed is:

1. A method for inputting a function key in a terminal equipped with a touch-screen, the method comprising the steps of:
determining whether a Press event occurs in a function key area enabling selective use of any direction keys and cursor movement keys;
when the Press event occurs, respectively assigning any of the direction keys and cursor movement keys to key areas, and displaying the keys respectively assigned to the key areas; and
when a Release event occurs in the function key area, releasing the assignment of the displayed keys to restore each of the key areas to a display state that was present before the occurrence of the Press event, and displaying the restored key areas.

2. The method as claimed in claim 1, which further comprises respectively assigning other direction keys or cursor movement keys to the key areas, and displaying the keys respectively assigned to the key areas, when a Press event occurs in the function key area.

3. The method as claimed in claim 1, wherein the direction keys comprise at least one of an upward (↑) key, a downward (↓) key, a leftward (←) key, and a rightward (→) key.

4. The method as claimed in claim 1, wherein the cursor movement keys comprise at least one of a Page Up key, a Page Down key, a Home key, and an End key.

5. The method as claimed in claim 1, wherein an identifier for indicating any currently selected direction keys or cursor movement keys is displayed in the function key area.

6. The method as claimed in claim 3, further comprising:
determining whether a Drag event occurs in a state of displaying any of the direction keys and the cursor movement keys; and
directing any of the key areas in a direction of a Drag event when a Drag event occurs; and
performing a function corresponding to the directed key area when a Release event occurs in the directed key area.

7. The method as claimed in claim 6, wherein, in the step of performing a function corresponding to the directed key area, a location of a cursor displayed in an input editor window is moved in a relevant direction of displayed any of the direction keys when any of the direction keys is displayed in the directed key area.

8. The method as claimed in claim 6, wherein, in the step of performing a function corresponding to the directed key area, a location of a cursor displayed in an input editor window is moved either on a sentence-by-sentence basis or on a page-by-page basis in a relevant direction of displayed any of the cursor movement keys when any of the cursor movement keys is displayed in the directed key area.

9. The method as claimed in claim 4, further comprising:
determining whether a Drag event occurs in a state of displaying any of the direction keys and cursor movement keys; and
directing any of the key areas in a direction of a Drag event when a Drag event occurs; and
performing a function corresponding to the directed key area when a Release event occurs in the directed key area.

10. The method as claimed in claim 9, wherein, in the step of performing a function corresponding to the directed key area, a location of a cursor displayed in an input editor window is moved in a relevant direction of displayed any of the direction keys when any of the direction keys is displayed in the directed key area.

11. The method as claimed in claim 9, wherein, in the step of performing a function corresponding to the directed key area, a location of a cursor displayed in an input editor window is moved either on a sentence-by-sentence basis or on a page-by-page basis in a relevant direction of displayed any of the cursor movement keys when any of the cursor movement keys is displayed in the directed key area.

12. The method as claimed in claim 1, wherein the step of respectively assigning any of the direction keys and cursor movement keys to key areas and displaying the keys comprises:
measuring an elapsed time from a time point of the occurrence of the Press event when the Press event occurs in the function key area;
when a Release event occurs in the function key area, respectively assigning any of the direction keys and cursor movement keys to the key areas depending on whether the measured time exceeds a critical time, and displaying the keys respectively assigned to the key areas.

13. The method as claimed in claim 1, wherein, in the step of respectively assigning any of the direction keys and cursor movement keys to key areas and displaying the keys, any of the direction keys and cursor movement keys are displayed in either two or more character areas respectively assigned at least one character for character input or a pop-up window.

14. An apparatus for inputting a function key, the apparatus comprising:
a touch-screen for outputting a character received as an input, displaying a function key area enabling selective use of any direction keys and cursor movement keys, and generating any of a Press event, a Release event, and a Drag event in response to an input of a user;
a memory for storing therein functions respectively corresponding to the direction keys and cursor movement keys; and
a control unit for controlling the touch-screen to display the function key area on the touch-screen, respectively assigning any of the direction keys and cursor movement keys to key areas and displaying the keys respectively assigned to the key areas when the Press event occurs in the function key area, and releasing the assignment of the displayed keys to restore each of the key areas to a display state that was present before the occurrence of the Press event and displaying the restored key areas when the Release event occurs in the function key area.

15. The apparatus as claimed in claim 14, wherein the control unit assigns keys corresponding to other direction keys or cursor movement keys to the key areas, respectively, and displays the keys respectively assigned to the key areas, when a Press event occurs in the function key area after restoring the key areas and displaying the restored key areas.

16. The apparatus as claimed in claim 14, wherein the control unit displays at least one of an upward (↑) key, a downward (↓) key, a leftward (←) key, and a rightward (→) key when displaying the direction keys.

17. The apparatus as claimed in claim 14, wherein the control unit displays at least one of a Page Up key, a Page Down key, a Home key, and an End key when displaying the cursor movement keys.

18. The apparatus as claimed in claim 14, wherein the control unit displays an identifier for indicating any currently selected from among the direction keys and the cursor movement keys in the function key area.

19. The apparatus as claimed in claim 16, the control unit directs any of the key areas in a direction of a Drag event when a Drag event occurs in a state of displaying any of the direction keys and cursor movement keys, and performs a function corresponding to the directed key area when a Release event occurs in the directed key area.

20. The apparatus as claimed in claim 19, wherein the control unit moves a location of a cursor displayed in an input editor window in a relevant direction of any of the direction keys when any of the direction keys is displayed in the directed key area.

21. The apparatus as claimed in claim 19, wherein the control unit moves a location of a cursor displayed in an input editor window either on a sentence-by-sentence basis or on a page-by-page basis in a relevant direction of displayed any of the cursor movement keys when any of the cursor movement keys is displayed in the directed key area.

22. The apparatus as claimed in claim 17, the control unit directs any of the key areas in a direction of a Drag event when a Drag event occurs in a state of displaying any of the direction keys and cursor movement keys, and performs a function corresponding to the directed key area when a Release event occurs in the directed key area.

23. The apparatus as claimed in claim 22, wherein the control unit moves a location of a cursor displayed in an input editor window in a relevant direction of any of the direction keys when any of the direction keys is displayed in the directed key area.

24. The apparatus as claimed in claim 22, wherein the control unit moves a location of a cursor displayed in an input editor window either on a sentence-by-sentence basis or on a page-by-page basis in a relevant direction of any of the cursor movement keys when any of the cursor movement keys is displayed in the directed key area.

25. The apparatus as claimed in claim 14, wherein the control unit measures an elapsed time from a time point of the occurrence of the Press event when the Press event occurs in the function key area; and wherein the control unit respectively assigns any of the direction keys and cursor movement keys to the key areas depending on whether the measured time exceeds a critical time, and displays the keys respectively assigned to the key areas, when a Release event occurs in the function key area.

26. The apparatus as claimed in claim 14, wherein the control unit displays any of the direction keys and cursor movement keys in either two or more character areas respectively assigned at least one character for character input or a pop-up window.
